(19) United States
(12) Patent Application Publication
(10) Pub. No.: US 2009/0137247 A1
(43) Pub. Date: May 28, 2009

(54) Channel scanning method and apparatus for use in dual-mode mobile station

(75) Inventor: In-Young Mok, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/313,800

(22) Filed: Nov. 25, 2008

(30) Foreign Application Priority Data
Nov. 28, 2007 (KR) 10-2007-0121922

(51) Int. Cl. H04W 74/00

(52) U.S. Cl. 455/434

(57) ABSTRACT

A channel scanning method and apparatus for use in a dual-mode mobile station are provided. A mobile communication interface is wirelessly connected to a mobile communication network. An unlicensed wireless interface is wirelessly connected to an unlicensed wireless network and based on Internet protocol. A storage stores at least one element of priority channel information and scan period information for searching for a wireless local area network access point (WLAN AP) of the unlicensed wireless network. A central processor alternately scans all channels and priority channels in order to search for the WLAN AP according to the scan period information stored in the storage. The number of channels to be scanned can be minimized by alternately scanning channels, and consumption of electricity can be minimized by reducing the number of scans during a given time in a region where the unlicensed wireless network is not configured.

### CROSS-REFERENCE TO RELATED APPLICATION(S) AND CLAIM OF PRIORITY

This application claims the benefit under 35 U.S.C. §119(a) from an application entitled “Channel Scanning Method and Apparatus For Use In Dual-mode Mobile Station” filed on Nov. 28, 2007 and assigned Ser. No. 2007-0121922, the entire contents of which are hereby incorporated herein by reference.

### TECHNICAL FIELD OF THE INVENTION

The present invention relates to a channel scanning method and apparatus for use in a dual-mode mobile station (MS), and more particularly, to a channel scanning method and apparatus for use in a dual-mode MS that can minimize the number of channels to be scanned when a dual-mode MS capable of accessing both a mobile communication network and an unlicensed wireless network alternately scans a basic access channel set by a user, priority channels constituting basic channels initially set in a wireless local area network access point (WLAN AP), and all channels, can minimize consumption of electricity by decreasing the number of scans during a given time by increasing a scan period in an environment in which the unlicensed wireless network is not configured, and can prevent a handover from being delayed by decreasing a scan period or resetting the scan period to a minimum value when the scan period reaches a maximum value.

### BACKGROUND OF THE INVENTION

An existing unlicensed wireless network (for example, Wi-Fi, Bluetooth, or the like), a global system for mobile communications (GSM)/general packet radio service (GPRS) or universal mobile telecommunications system (UMTS) mobile communication network, and a code division multiple access (CDMA) mobile communication network have been redundantly constructed as separate networks.

The unlicensed wireless network has advantages of a relatively high service rate and low service cost but has disadvantages of a relatively narrow service area and low mobility. On the other hand, the GSM/GPRS, UMTS, or CDMA mobile communication network has disadvantages of a relatively slow service rate and high service cost but has advantages of a relatively wide service area and high mobility.

Recently, an unlicensed mobile access (UMA) technology serving as a convergence technology has been developed by mutually coupling and interfacing the unlicensed wireless network and the GSM/UMTS mobile communication network, using the advantages thereof. Also, dual-mode mobile communication terminals (dual-mode MSs) capable of accessing both the unlicensed mobile network and the GSM/UMTS mobile communication network have been developed.

The UMA technology is different from a wired/wireless combination technology for interfacing a mobile communication core network and a voice over Internet protocol (VoIP) network in that a UMA network controller (UNC) for performing a function of a base station controller (BSC) may transparently provide voice, data, and additional services from a mobile communication network through an AP of the unlicensed wireless network (that is, a WLAN AP) without modifying a mobile telephone switching office (MTSO) or mobile switching center (MSC), a serving GPRS support node/packet data service node (SGSN/PDSN), a home location register (HLR), or other equipment of an existing mobile communication core network.

When the UMA technology is used, users may receive a service from the mobile communication network through an unlicensed wireless network such as Wi-Fi or Bluetooth and may take advantage of the relatively high service rate and low service cost. From the viewpoint of a mobile communication provider, shadow areas may be eliminated at low cost, service areas may be extended by installing a wired IP network and a WLAN AP in shadow areas of a mobile communication network such as indoor areas, and profits may increase since it is possible to change from a conventional wired telephone environment, such as an indoor environment, to a mobile phone environment.

When the UMA technology is used, subscribers may receive consistent mobile communication voice and data services using dual-mode terminals or MSs. For this, the handover of a voice call and data session may be supported between the mobile communication network and the unlicensed wireless network, such that seamless roaming service may be received.

In general, a dual-mode MS capable of accessing both the unlicensed wireless network and the mobile communication network (GSM/UMTS mobile communication network) may search for a WLAN AP having a relatively narrow service area in a state in which the dual-mode MS has accessed a mobile communication network having a relatively wide service area. When the WLAN AP is scanned or searched for, the dual-mode MS may access the unlicensed wireless network through the WLAN AP.

Accordingly, the dual-mode MS should determine whether the WLAN AP is scanned or searched for by continuously scanning all channels.

For example, the dual-mode MS scans the channels according to a protocol defined in an IEEE 802.11 standard. Scanning modes may be classified into an active scanning mode and a passive scanning mode.

FIG. 1 is a flow diagram illustrating the active scanning mode.

Referring to FIG. 1, an MS 10 determines whether there is a WLAN AP 20 adjacent thereto and periodically broadcasts a probe request (frame) on all channels (channels 1˜11 in the United States) (S1).

When the probe request is received, the WLAN AP 20 transmits a probe response (frame) to the MS 10 (S2). The probe response transmitted from the WLAN AP 20 includes access information of a service set identifier (SSID) of a corresponding WLAN AP, a supportable transmission rate, a beacon interval, or the like.

Accordingly, the MS 10 acquires all information for wirelessly accessing the corresponding WLAN AP 20 through the probe response.

In the active scanning mode described above, a time in which the MS 10 waits for the probe response to be received depends on a minimum value Tmin and a maximum value Tmax after the probe request is broadcast. That is, after the probe request is broadcast, the MS 10 constantly waits for the probe response to be received for a time of the minimum value. When the probe response is not received in the time of the minimum value, the MS 10 waits for the probe response to be received for a time of the maximum value. When the response is received in a reception waiting state, the next channel is scanned and then all channels are scanned.

On the other hand, the passive scanning mode is an operating mode in which the MS 10 may search for the adjacent WLAN AP 20 by receiving a beacon message therefrom. The beacon message is periodically transmitted as a message containing information indicating whether there is a frame to be transmitted from the WLAN AP 20 to the MS along with an SSID in a unicast, multicast, or broadcast mode. Like the probe response of the active scanning mode, the beacon message includes all information for accessing the WLAN AP 20.

That is, the scanning modes in which the MS 10 searches for the WLAN AP 20 include the active scanning mode in which the MS 10 automatically or actively broadcasts a request message on all channels, receives a response message from the WLAN AP 20, and searches for the WLAN AP 20, and the passive scanning mode in which the MS 10 passively searches for the WLAN AP 20 using a beacon message transmitted therefrom.

At present, the dual-mode MS capable of accessing both the unlicensed wireless network and the mobile communication network uses both the active scanning mode and the passive scanning mode.

After the probe request is broadcast in the active scanning mode, the WLAN AP is searched for using both the probe response received during a reception waiting time and the beacon message received from the WLAN AP.

In the dual-mode MS, operating modes for searching for and accessing a WLAN AP may be classified into an automatic mode and a manual mode.

First, the automatic mode is applied to set a function when the dual-mode MS automatically accesses a WLAN AP. When a WLAN AP serving as a basic AP is searched for, the dual-mode MS attempts to access a corresponding WLAN AP. When the WLAN AP serving as the basic AP is not found, all channels are continuously scanned to search therefor.

When a user directly inputs a scanning start to the dual-mode MS in the manual mode, the dual-mode MS starts a scanning operation to search for a WLAN AP.

In general, the access mode of the dual-mode MS uses the automatic mode. When the dual-mode MS enters a service area of the unlicensed wireless network in a state in which the mobile communication network has been accessed in the automatic mode, a handover to the unlicensed wireless network is performed by an automatic scanning operation and an access attempt. In the manual mode, the handover to the unlicensed wireless network should be performed when the user manually (directly) starts the scanning operation after entering the unlicensed wireless network. Consequently, the automatic mode is more convenient and efficient than the manual mode.

However, when a WLAN AP is searched for in the automatic mode, the dual-mode MS should continuously scan all channels in order to determine whether the dual-mode MS enters the unlicensed wireless network or the basic access AP is present. For this reason, consumption of electricity required for scanning the channels may increase.

That is, even when the dual-mode MS is located in an environment in which no unlicensed wireless network is present, all channels should be continuously scanned in order to search for the, WLAN AP. For this reason, electricity may be unnecessarily consumed.

Accordingly, since the dual-mode MS having a low-capacity battery consumes a large amount of electricity in order to scan channels, battery life may be shortened.

### SUMMARY OF THE INVENTION

To address the above-discussed deficiencies of the prior art, it is a primary object of the present invention to provide an improved channel scanning method and apparatus for use in a dual-mode MS capable of accessing both an unlicensed wireless network and a mobile communication network. The improved channel scanning method and apparatus can minimize consumption of electricity when the dual-mode MS scans channels in order to search for a WLAN AP of the unlicensed wireless network.

According to an aspect of the present invention, there is provided a dual-mode MS for use in a convergence service system including a mobile communication network and an unlicensed wireless network, the dual-mode MS including: a mobile communication interface wirelessly connected to the mobile communication network; an unlicensed wireless interface wirelessly connected to the unlicensed wireless network based on Internet protocol; a storage that stores at least one element of priority channel information and scan period information for searching for a WLAN AP of the unlicensed wireless network; and a central processor that alternately scans all channels and priority channels in order to search for the WLAN AP according to the scan period information stored in the storage.

The scanning processor may increment a value of the scan period information when the WLAN AP is not found using at least one of all the channels and the priority channels in a given time. The scanning processor may perform at least one of an operation for decrementing the value of the scan period information and an operation for resetting the scan period information to a minimum value when the scan period information reaches a set maximum value.

The dual-mode MS may further include an input unit that receives at least one element of basic access channel information based on basic access AP information and the scan period information from a user.

According to another aspect of the present invention, there is provided a method for scanning channels in an MS of a convergence service system including a mobile communication network and an unlicensed wireless network, including the steps of: setting at least one element of basic channel information input from a user and priority channel information based on basic channel information initially set in a WLAN AP through which the unlicensed wireless network is accessed; alternately selecting and scanning at least one element of the priority channel information and all-channel information according to scan period information for searching for the WLAN AP in a state in which the mobile communication network has been accessed; and scanning at least one element of the all-channel information and the parity channel information selected when the WLAN AP is not found after a predetermined number of periods using the at least one element of the priority channel information and the all-channel information.

The method may further include the steps of: accessing the unlicensed wireless network through the WLAN AP when the WLAN AP is found using at least one element of all-channel information and the priority channel information; incrementing a value of the scan period information when the WLAN AP is not found in a given time; and performing at least one of an operation for decrementing the value of the scan period information and an operation for resetting the value of the scan period information to a minimum value when the scan period information reaches a maximum value.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram illustrating an active scanning mode;

FIG. 2 is a schematic diagram illustrating a convergence service system including a dual-mode MS capable of accessing both an unlicensed wireless network and a mobile communication network according to an exemplary embodiment of the present invention;

FIG. 3 is a schematic block diagram illustrating a configuration of the dual-mode MS according to an exemplary embodiment of the present invention; and

FIG. 4 is a flowchart illustrating a method in which the dual-mode MS of the convergence service system scans channels according to an exemplary embodiment of the present invention.

### DETAILED DESCRIPTION OF THE INVENTION

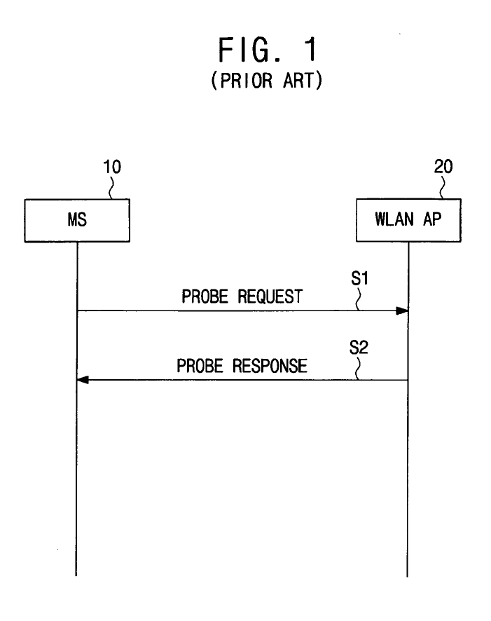

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile station.

Hereinafter, a channel scanning method and apparatus for use in a dual-mode MS according to exemplary embodiments of the present invention will be described in detail with reference to the accompanying drawings.

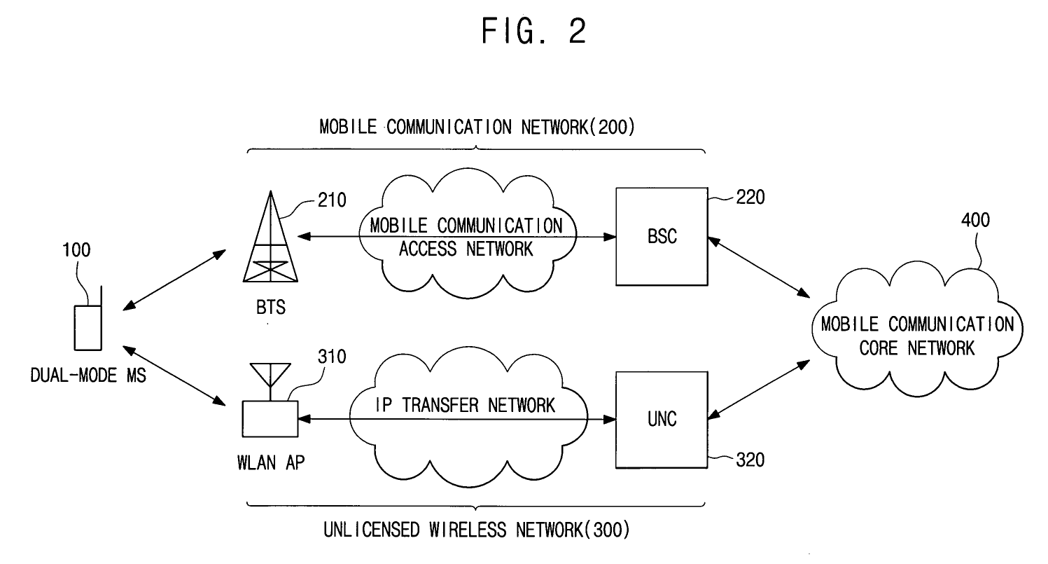

FIG. 2 is a schematic diagram illustrating a convergence service system including a dual-mode MS capable of accessing both an unlicensed wireless network and a mobile communication network according to an exemplary embodiment of the present invention.

As illustrated in FIG. 2, a mobile communication network 200 can be a GSM/GPRS or UMTS mobile communication network or a CDMA mobile communication network, and an unlicensed wireless network 300 can be a Wi-Fi or Bluetooth network.

The mobile communication network 200 includes a base transceiver station (BTS) 210 and a BSC 220. The unlicensed wireless network 300 includes a WLAN AP 310 for processing a function similar to that of the BTS 210 and a UNC 320 for processing a function similar to that of the BSC 220.

A mobile communication access network is implemented between the BTS 210 and the BSC 220, thereby configuring the mobile communication network 200. An IP-based transfer network (that is, an IP transfer network) is implemented between the WLAN AP 310 and the UNC 320, thereby configuring the unlicensed wireless network 300.

A dual-mode MS 100 is a mobile communication terminal capable of accessing both the mobile communication network 200 and the unlicensed wireless network 300. In a state in which the mobile communication network 200 has been accessed, the dual-mode MS 100 receives service through the mobile communication network 200. In a state in which the unlicensed wireless network 300 has been accessed, the dual-mode MS 100 receives service through the unlicensed wireless network 300. That is, the dual-mode MS 100 receives voice, data, and additional services by accessing a mobile communication core network 400 through the mobile communication network 200 or the unlicensed wireless network 300.

The mobile communication core network 400 is constructed by a mobile communication service provider and is provided with an MTSO or MSC, an SGSN/PDSN, an HLR, and the like, serving as equipment for providing service. The mobile communication core network 400 provides service to the dual-mode MS 100 having access through the mobile communication network 200 or the unlicensed wireless network 300.

When the dual-mode MS 100 accesses the mobile communication network 200 (for example, a CDMA mobile communication network), the dual-mode MS 100 receives service by accessing the mobile communication core network 400 through a mobile communication access network while communicating with the BSC 220 using CDMA L3 protocol. When accessing the unlicensed wireless network 300, the dual-mode MS 100 receives service by accessing the CDMA core network 400 while communicating with the UNC 320 using an UMA-L3-CDMA protocol in which a CDMA L3 protocol message is transmitted in an IP packet. At this time, the dual-mode MS 100 establishes an IP communication path to the UNC 320 by accessing the WLAN AP 310 through an unlicensed wireless interface (modem) 112 to be described later.

The WLAN AP 310 can wirelessly communicate with the dual-mode MS 100 in an unlicensed wireless system (such as Wi-Fi, Bluetooth, or the like), provide an IP-based wireless communication environment to the dual-mode MS 100, and establish an IP communication path to the UNC 320.

The UNC 320 performs a function similar to that of the BSC by accessing the MSC and the SGSN/PDSN of the mobile communication core network 400. When the UNC 320 is connected to the WLAN AP 310 through the unlicensed wireless network 300, the dual-mode MS 100 can have IP-based wireless access. Since a function similar to that of the BSC is performed, the UNC 320 not only can communicate with the dual-mode MS 100 in UMA protocol corresponding to CDMA L3 protocol, but also can support a handoff between the mobile communication network 200 and the unlicensed wireless network 300. Accordingly, the UNC 320 enables the dual-mode MS 100 to receive seamless roaming and transparent services on the move.

The dual-mode MS 100 continuously scans channels in a search for the WLAN AP 310 in order to access the unlicensed wireless network 300.

An example in which the access mode of the dual-mode MS is set to the more efficient automatic mode rather than the manual mode will be described.

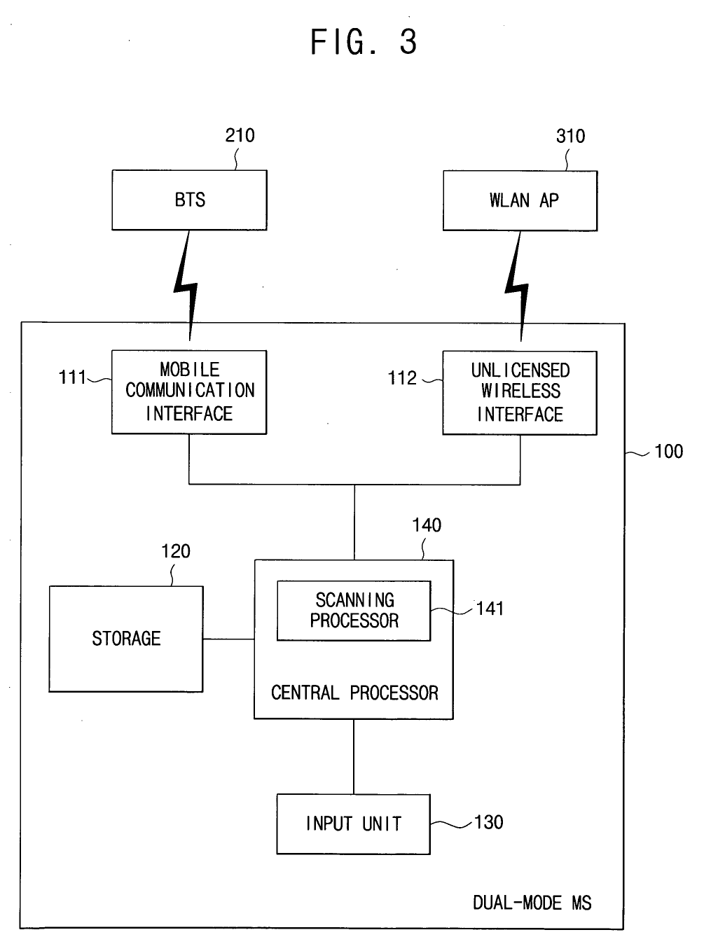

FIG. 3 is a schematic block diagram illustrating a configuration of the dual-mode MS according to an exemplary embodiment of the present invention.

Referring to FIG. 3, the dual-mode MS 100 according to the exemplary embodiment of the present invention includes a mobile communication interface 111 wirelessly connected to the BTS 210 of the mobile communication network 200, the unlicensed wireless interface 112 wirelessly connected to the WLAN AP 310 of the unlicensed wireless network 300, a storage 120 for storing operation information of the dual-mode MS 100, basic access AP information, priority channel information, scan period information, and the like, an input unit 130 for receiving input information from a user, and a central processor 140 for providing the user with service by accessing the mobile communication core network 400 through the mobile communication interface 111 or the unlicensed wireless interface 112. The central processor 140 includes a scanning processor 141 for performing a scanning process to search for the WLAN AP 310 accessible through the unlicensed wireless interface 112.

The dual-mode MS 100 further includes a voice input and output unit (not illustrated) for receiving a voice input from the user and outputting a voice input from another party when a call for voice communication is set up, and a display (not illustrated) implemented with a display element such as a liquid crystal display (LCD) for outputting a screen based on data downloaded from the mobile communication core network 400, thereby providing the user with voice, data, and additional services.

Since a method for providing voice, data, and additional services in the dual-mode MS is well known, a detailed description thereof is omitted.

The mobile communication interface 111 enables the dual-mode MS 100 to wirelessly access the BTS 210 of the mobile communication network 200 on the basis of mobile communication and to exchange data with the mobile communication core network 400 accessed through the mobile communication network 200.

The unlicensed wireless interface 112 enables the dual-mode MS 100 to wirelessly access the WLAN AP 310 of the unlicensed wireless network 300 based on IP and to exchange data with the mobile communication core network 400.

The input unit 130 can be implemented with a plurality of keys and transmits input information from the user to the central processor 140. The input information can be basic access AP information, priority channel information, scan period information, and the like.

The storage 120 stores input information received through the input unit 130 (that is, basic access AP information, basic access channel information, basic channel information, priority channel information, scan period information, operation information, history information, program information, and the like) for the dual-mode MS 100.

The central processor 140 accesses the mobile communication core network 400 through the mobile communication network 200 or the unlicensed wireless network 300 by means of the mobile communication interface 111 or the unlicensed wireless interface 112. In a state in which the mobile communication network 200 has been accessed, the central processor 140 searches for the WLAN AP 310 by scanning channels through the unlicensed wireless interface 112 according to a scan period.

When the WLAN AP is searched for, the central processor 140 accesses the WLAN AP 310 through a corresponding channel, such that a handover is performed from the mobile communication network 200 to the unlicensed wireless network 300.

In a state in which the dual-mode MS 100 has accessed the mobile communication network 200, the scanning processor 141 of the central processor 140 periodically scans channels according to the scan period information stored in the storage 120.

The scan period information for channel scanning by the scanning processor 141 can be directly set by the user through the input unit 130 or can be appropriately adjusted in a process for searching for the WLAN AP 310.

For example, when the WLAN AP 310 is not found in a given time, the scanning processor 141 increments a value of the scan period information (for example, 15 sec→15 sec→30 sec→30 sec →60 sec→60 sec→120 sec→120 sec→120 sec→120 sec - - - ) and minimizes consumption of electricity when channels are scanned to search for the WLAN AP 310.

That is, the scanning processor 141 minimizes consumption of electricity in a scanning process to search for the WLAN AP 310 by incrementing the value of the scan period information in an environment in which the unlicensed wireless network 300 is not configured.

On the other hand, since a time required to search for the WLAN AP 310 may be increased and the handover may be delayed when the dual-mode MS 100 enters an environment in which the unlicensed wireless network 300 is configured, if the value of the scan period information excessively increases, the scanning processor 141 should properly increment the value of the scan period information. A maximum value of the scan period information can be set by experimentation. When the scan period information increases to the maximum value, the dual-mode MS 100 can prevent the handover from being delayed by regularly decrementing the value of the scan period information or setting the scan period information to a minimum value.

The scanning processor 141 alternately scans priority channels based on priority channel information and all channels according to the set scan period information.

Table 1 shows scan period information and scan channel information.

TABLE 1

| | Scan Period Info | |
|---|---|---|
| Period | (sec) | Scan Channel Info |
| 0 | 15 | All channels |
| 1 | 15 | Priority channels |
| 2 | 15 | Priority channels |
| 3 | 15 | All channels |
| 4 | 15 | Priority channels |
| 5 | 15 | Priority channels |
| 6 | 15 | All channels |
| — | | — |

As shown in Table 1, the scanning processor 141 alternately selects all channels (for example, channels 1˜11) and the priority channels (for example, channels 1, 3, 6, and 9) as channels to be scanned.

The following Table 2 shows scan period information and scan channel information in a region where the unlicensed wireless network 300 is not configured.

TABLE 2

| | Scan Period Info | |
|---|---|---|
| Period | (sec) | Scan Channel Info |
| 0 | 15 | All channels |
| 1 | 15 | Priority channels |
| 2 | 30 | Priority channels |
| 3 | 30 | All channels |
| 4 | 60 | Priority channels |
| 5 | 60 | Priority channels |
| 6 | 120 | All channels |
| — | | — |

As shown in Table 2, the scanning processor 141 alternately selects all channels and the priority channels as channels to be scanned, and minimizes the number of scans by regularly incrementing the value of the scan period information in a region where the unlicensed wireless network 300 is not configured.

Among the channels to be scanned by the scanning processor 141, the priority channels can be basic channels (for example, channels 1, 6, and 11) basically set in the WLAN AP 310 and a basic access channel (for example, channel 3) of a basic access AP.

For example, when the WLAN AP 310 (a basic access AP) to be accessed by the dual-mode MS 100 is installed in an indoor area of the user, the user can set a channel designated in the indoor WLAN AP 310 to the basic access channel (for example, channel 3) through the dual-mode MS 100.

On the other hand, basic channels are channels set by a manufacturer of the WLAN AP 310 or an operator for installing and operating the WLAN AP 310. In general, the basic channels are set to channels for avoiding channel redundancy (for example, channels 1, 6, and 11).

For example, the SSID of the WLAN AP 310 can be set to ‘Hotspot’ or ‘@HomeXXXX’ (where X is a hexadecimal number). The WLAN AP 310 is connected to the dual-mode MS 100 using the basic channels, and the dual-mode MS 100 can access the unlicensed wireless network 300.

Accordingly, the basic channels of the WLAN AP 310 can be used as channels set at an initial installation time and can be changed if required. In general, since the unlicensed wireless network 300 is configured on the basis of the basic channels, it is quite likely that the WLAN AP 310 can be found by scanning only the priority channels (that is, the basic channels and the basic access channel) without scanning all channels in the dual-mode MS 100.

The scanning processor 141 periodically scans channels on the basis of the scan period information and the scan channel information stored as shown in Table 1 or 2.

For example, when the scanning processor 141 scans the channels on the basis of Table 1, all channels should be scanned in a ‘0’ period. Accordingly, the scanning processor 141 broadcasts a probe request (frame) on all the channels and waits for a probe response to be received.

When the probe response is received from the WLAN AP 310 in a reception waiting time, the scanning processor 141 accesses the WLAN AP 310 through a corresponding channel. When a probe response is not received in the reception waiting time (or the reception waiting time of the maximum value), the scanning processor 141 transmits (multicasts) the probe request on only the priority channels (for example, channels 1, 3, 6, and 11) in a ‘1’ period and waits for the probe response to be received.

Accordingly, the scanning processor 141 can minimize consumption of electricity in a scanning process of the dual-mode MS 100 by alternately scanning only the priority channels without periodically scanning all the channels.

For example, when the dual-mode MS 100 scans the channels in the ‘0’ and ‘1’ periods, 22(11+11) channels should be scanned in the conventional art, but only 15(11+4) channels need be scanned according to an exemplary embodiment of the present invention. According to the exemplary embodiment of the present invention, consumption of electricity in the scanning process can be reduced by significantly reducing the number of channels to be scanned.

On the other hand, when all channels and the priority channels are scanned, the scanning processor 141 can scan the priority channels in a predetermined number a of periods after scanning all channels. Tables 1 and 2 show examples in which a is 3.

When a is incremented, a value of the period in which only the priority channels are scanned is incremented, and consumption of electricity is minimized. Since a time taken to access a corresponding WLAN AP 310 increases when the WLAN AP 310 must be accessed through a channel other than the priority channels, the value of a can be properly adjusted.

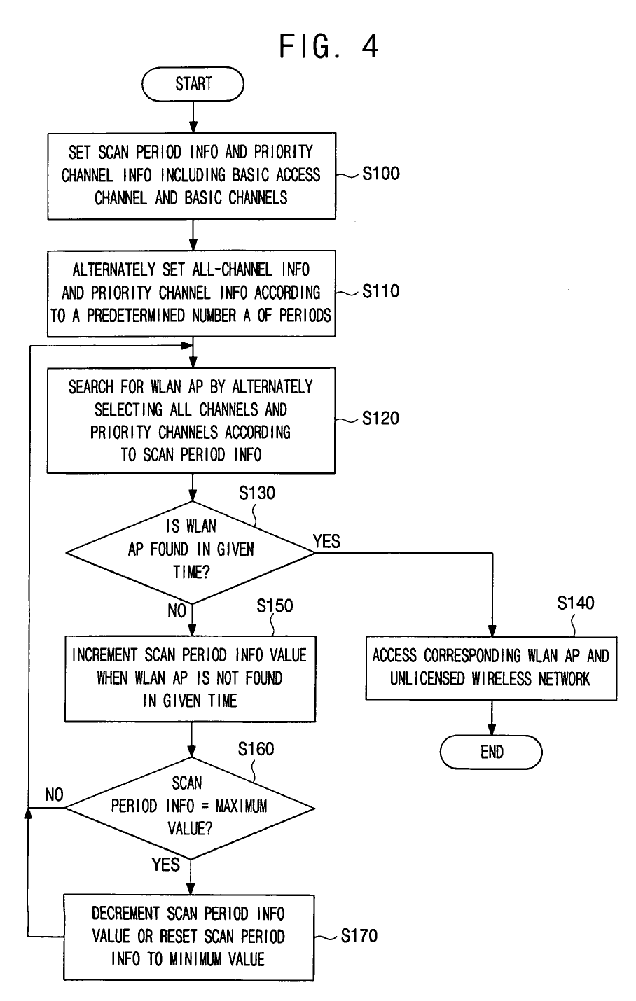

FIG. 4 is a flowchart illustrating a method in which the dual-mode MS of the convergence service system scans channels according to an exemplary embodiment of the present invention.

Referring to FIG. 4, the dual-mode MS 100 capable of accessing both the mobile communication network 200 and the unlicensed wireless network 300 sets and stores priority channel information and scan period information (S100).

The dual-mode MS 100 sets basic access AP information from the user and priority channel information based on basic channels (for example, channels 1, 6, and 11) set by the manufacturer of the WLAN AP 310 or the operator for installing and operating the WLAN AP 310.

The dual-mode MS 100 alternately sets the priority channel information serving as the scan channel information for searching for the WLAN AP 310 in order to access the unlicensed wireless network 300 and all-channel information (S110). At this time, the dual-mode MS 100 scans all channels and sets scan channel information such that priority channels are scanned in a number of periods.

When the user inputs the scan period information, the dual-mode MS 100 sets and stores the input scan period information.

In a state in which the mobile communication network 200 has been accessed, the dual-mode MS 100 searches for the WLAN AP 310 through which the unlicensed wireless network 300 is accessed according to the set scan period information. That is, the dual-mode MS 100 alternately selects all channels and the priority channels and performs a scanning process for searching for the WLAN AP 310 (S120).

That is, the dual-mode MS 100 alternately scans only the priority channels without periodically scanning all channels, thereby minimizing consumption of electricity in a channel scanning process.

On the other hand, the dual-mode MS 100 determines whether the WLAN AP 310 is found in a given time while alternately scanning all channels and the priority channels (S130). When the WLAN AP 310 is found in the given time, the dual-mode MS 100 accesses the corresponding WLAN AP 310 and accesses the unlicensed wireless network (S140).

When the WLAN AP 310 is not found in the given time, the dual-mode MS 100 increments a value of the scan period information, thereby minimizing consumption of electricity for channel scanning in order to search for the WLAN AP 310 (S150). That is, when the dual-mode MS 100 is located in a region where the unlicensed wireless network 300 is not configured, consumption of electricity can be minimized by lengthening a period in which channels are scanned by incrementing the value of the scan period information for searching for the WLAN AP 310.

The dual-mode MS 100 determines whether the scan period information reaches a set maximum value (S160). When the scan period information reaches the maximum value, the value of the scan period information is decremented or the scan period information is reset to a minimum value (S170).

If the value of the scan period information is excessively large, the time taken to search for the WLAN AP 310 may be too long, and a handover may be delayed when the dual-mode MS 100 enters a region where the unlicensed wireless network 300 is configured. Accordingly, the scan period information is properly adjusted, thereby preventing handover delay.

Consumption of electricity was measured for a scanning method of the dual-mode MS proposed by the present invention and for a conventional scanning method, and the results are compared below.

Table 3 lists consumption of electricity measurements, and the conditions under which the measurements were taken.

TABLE 3

| Access Mode | Automatic Mode |
|---|---|
| MS state | Idle |
| Unlicensed wireless network | Absent |
| All channels | 1~11 |
| Priority channels | 1, 3, 6, 11 |
| Factor a of given multiple | 2 |
| Measurement time | 20 min |
| Consumption (mA) according to proposed | 2.8 |
| method | |
| Consumption (mA) according to | 3.3 |
| conventional method | |

As shown in Table 3, the access mode was set to the automatic mode. In the current idle state, the following average values were computed by measuring consumption of electricity of the dual-mode MS during 20 min in a region where the unlicensed wireless network 300 is not implemented:
1) Consumption according to the proposed method: 2.8 mA
2) Consumption according to the conventional method: 3.3 mA

That is, when the dual-mode MS periodically scanned all channels for 20 min according to the conventional method, the consumption of electricity was 3.3 mA. When the factor a for selecting all channels and the priority channels was 2 and all channels/the priority channels were alternately selected and scanned for 20 min according to the inventive method, the consumption of electricity was 2.8 mA. Thus, consumption of electricity was reduced by about 15.16%.

According to exemplary embodiments of the present invention, a channel scanning method and apparatus for use in a dual-mode MS can minimize the number of channels to be scanned when the dual-mode MS capable of accessing both a mobile communication network and an unlicensed wireless network alternately scans a basic access channel set by a user, priority channels constituting basic channels initially set in a WLAN AP, and all channels.

The channel scanning method and apparatus for use in the dual-mode MS can minimize consumption of electricity by decreasing the number of scans during a given time by increasing a scan period when no WLAN AP is searched for during the given time (that is, in an environment in which the unlicensed wireless network is not configured) and can prevent a handover from being delayed by decreasing a scan period or resetting the scan period to a minimum value when the scan period reaches a maximum value.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A dual-mode mobile station for use in a convergence service system including a mobile communication network and an unlicensed wireless network, the dual-mode mobile station comprising:
a mobile communication interface wirelessly connected to the mobile communication network;
an unlicensed wireless interface wirelessly connected to the unlicensed wireless network based on Internet protocol;
a storage that stores at least one element of a priority channel information and a scan period information for searching for a wireless local area network access point (WLAN AP) of the unlicensed wireless network; and
a central processor that alternately scans all channels and one or more priority channels in order to search for the wireless local area network access point according to the scan period information stored in the storage.

2. The dual-mode mobile station of claim 1, wherein the central processor includes:
a scanning processor that performs a scanning process for searching for the wireless local area network access point through a corresponding channel by alternately selecting all-channel information and the priority channel information for searching for the wireless local area network access point in a predetermined number of periods, in a state in which the mobile communication network has been accessed through the mobile communication interface.

3. The dual-mode mobile station of claim 2, wherein the priority channel information is set based on at least one element of a basic channel information input from a user and a basic channel information initially set in the wireless local area network access point.

4. The dual-mode mobile station of claim 2, wherein the scanning processor increments a value of the scan period information when the wireless local area network access point is not found using at least one of all the channels and the priority channels within a given time.

5. The dual-mode mobile station of claim 4, wherein the scanning processor performs at least one of an operation for decrementing the value of the scan period information and an operation for resetting the scan period information to a minimum value when the scan period information reaches a set maximum value.

6. The dual-mode mobile station of claim 2, wherein the scanning processor determines whether a probe response is received during a reception waiting time after transmitting a probe request on a channel selected from among all the channels and the priority channels, accesses the wireless local area network access point through a corresponding channel upon determining that the probe response is received, and transmits the probe request on at least one of all the channels and the priority channels selected according to the predetermined number of periods upon determining that the probe response was not received.

7. The dual-mode mobile station of claim 1, further comprising:
an input unit that receives at least one element of a basic access channel information based on basic access AP information and the scan period information from a user.

8. A method for scanning channels in a mobile station of a convergence service system including a mobile communication network and an unlicensed wireless network, comprising the steps of:
setting at least one element of a basic channel information input from a user and a priority channel information based on basic channel information initially set in a wireless local area network access point through which the unlicensed wireless network is accessed;
alternately selecting and scanning at least one element of the priority channel information and an all-channel information according to a scan period information for searching for the wireless local area network access point in a state in which the mobile communication network has been accessed; and
scanning at least one element of the all-channel information and the priority channel information selected when the wireless local area network access point is not found after a predetermined number of periods using the at least one element of the priority channel information and the all-channel information.

9. The method of claim 8, further comprising the step of:
accessing the unlicensed wireless network through the wireless local area network access point when the wireless local area network access point is found using the at least one element of the all-channel information and the priority channel information.

10. The method of claim 8, further comprising the steps of:
incrementing a value of the scan period information when the wireless local area network access point is not found within a given time; and
performing at least one of an operation for decrementing the value of the scan period information and an operation for resetting the value of the scan period information to a minimum value when the scan period information reaches a maximum value.

11. The method of claim 8, wherein the scanning step includes the steps of:
transmitting a probe request on a channel selected from among the all channels and the priority channels according to a predetermined number of periods;
determining whether a probe response is received during a reception waiting time;
accessing the wireless local area network access point through a corresponding channel upon determining that a probe response was received; and
transmitting the probe request on at least one of all the channels and the priority channels selected according to the predetermined number of periods upon determining that the probe response is not received.
